(19) United States
(12) Patent Application Publication
(10) Pub. No.: US 2015/0254567 A1
(43) Pub. Date: Sep. 10, 2015

(54) Method for Knowledge Capture and Pattern Recognition for the Detection of Hydrocarbon Accumulations

(71) Applicant: IMHOF, Matthias, Katy, TX (US)

(72) Inventor: Matthias Imhof, Katy, TX (US)

(21) Appl. No.: 14/434,727

(22) PCT Filed: Sep. 3, 2013
(86) PCT No.: PCT/US2013/057854

§ 371 Date: Apr. 9, 2015

Related U.S. Application Data
(60) Provisional application No. 61/723,628, filed on Nov. 7, 2012.

(51) Int. Cl. G06N 5/04; G01V 99/00

(52) U.S. Cl. CPC G06N 5/047; G01V 99/005

(57) ABSTRACT

The described method and system assist an interpreter in analyzing seismic (702), geophysical, or geoscience data. In particular, the method and system includes defining a conceptual model (712) of subsurface hydrocarbon accumulations; defining an interpretational model (710) linking observations to concepts; obtaining and entering observations into a database; querying the database (714) for instances of particular concepts or classifying observations with regard to different concepts; and repetition of the above steps for additional iterations.

### CROSS-REFERENCE TO RELATED APPLICATION

This application claims the benefit of U.S. Provisional Patent Application 61/723,628, filed Nov. 7, 2012, entitled METHOD FOR KNOWLEDGE CAPTURE AND PATTERN RECOGNITION FOR THE DETECTION OF HYDROCARBON ACCUMULATIONS, the entirety of which is incorporated by reference herein.

### FIELD OF THE INVENTION

This invention relates generally to the field of geophysical prospecting, and more particularly to the interpretation of seismic data. Specifically, the disclosure describes a pattern recognition method to analyze and mine seismic and geoscience data for potential hydrocarbon opportunities.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the disclosed methodologies and techniques. Accordingly, it should be understood that this section should be read in this light, and not necessarily as admissions of prior art.

An active hydrocarbon system is defined by the presence of a porous reservoir formation that provides storage space for hydrocarbons, a seal that prevents hydrocarbons from escaping the reservoir, a good trapping geometry, and a source formation that contains a high percentage of biogenic material. Under the influence of high temperature and increased pressure, the biogenic material is matured (or cooked) to form hydrocarbons, which include gas, crude oil, asphalts and/or tar. Driven by buoyancy and pressure differentials, the hydrocarbons migrate and a fraction of those hydrocarbons accumulates in traps formed by fortuitous geometric arrangements of reservoir formations (e.g., trapping geometries) and seals. Traps have a finite volume, however, and may spill or leak some of the accumulated hydrocarbons, a portion of which may then collect in other traps.

Seismic images of the subsurface provide images for interpreters to identify potential traps based on experience and suggestive geometries. While some seismic data may provide a direct indication for the presence of hydrocarbons, the conventional interpretation practices, however, are labor intensive and often focused on areas where the interpreter predicts potential accumulations. Many opportunities, therefore, remain undetected because the indications are too subtle or hidden, for example by seismic noise. Even if indications of potential accumulations are observed, the potential accumulations may not be examined when in the presence of more obvious opportunities or when the interpreter is limited by time constraints. Thus, some hydrocarbon accumulations may remain unidentified or may be identified later in the process.

To address this aspect, Intl. Patent Application No. 2011149609 describes a technique that utilizes the existence of prospectivity scores for essentially all voxels of a seismic dataset, skipping over the possibility of generating prospectivity scores for individual segments instead of individual voxels. Also, this reference describes that the technique should include a configuration catalogue that stores specific plays for reuse. By recognizing the need for a systematic approach to capture the configurations of specific plays, this reference describes that configurations are preferably represented in a formal manner, which is exemplified in a graphical representation for the configurations or as a relational database. However, the reference fails to provide how graph representations or relational databases may be used for querying for specified plays or classification of potential plays.

Other techniques describe approaches to manage data within a hydrocarbon production operation. As another example, U.S. Pat. No. 7,818,071 describes a system for controlling and optimizing production operations of hydrocarbon production wells and facilities, which are equipped with sensors that generate raw reservoir, production or production equipment performance data. This system collects raw data and processes the data in a central data center to produce component data and system performance data. The amount of raw data generated cannot be handled by a single person or team, and thus are presented using ontology-based visualization techniques. However, the reference fails to provide details about the ontology-based visualization techniques.

As another example, U.S. Pat. No. 7,895,241 describes a method to automatically generate an object-oriented application programming interface that allows oilfield data to be accessed from a data repository of various formats, for example relational databases. Applications include mapping one application programming interface to multiple data repositories with different formats or accessing oilfield data from different oilfield functions using consistent interface to request data based on oilfield entities. The mappings use a domain metamodel, a domain ontology, or a data model that describes the structure of the objects defined within a taxonomic type hierarchy and associated information, such as object properties that describe relations between objects and object properties that describe simple non-relational data associated with objects.

As yet another example, French Patent Application No. 2932280 describes a method to build an earth model composed of horizons and faults whose mutual relationships are fully defined in a geologically consistent manner. The relationships are modeled using an ontology. Aspects of the method are also disclosed in Verney et al., ‘A knowledge-based approach of seismic interpretation: horizon and dip-fault detection by means of cognitive vision’, SEG Las Vegas 2008 Annual Meeting, 2008, pp. 874-878; in Mastella et al., ‘Formalizing Geological Knowledge through Ontologies and Semantic Annotation’, 70th EAGE Conference & Exhibition, 2008; or in Rainaud et al., ‘A Knowledge-driven Shared Earth Modeling Workflow for Seismic Interpretation and Structural Model Building’, 72nd EAGE Conference & Exhibition, 2010.

As still yet another example in a different technology area, U.S. Patent Application Publication No. 20110099162 describes a representation of a collection of documents and texts characterized by features in a database and the determination of semantic space representations of features across the collection. The semantic representation allows determination of the relatedness between two features and aggregate relatedness across sets of feature pairs. The primary interest is relations between terms. Examples include ontology construction, electronic data discovery, and intelligence analysis. In particular, there is interest in determining the degree of relatedness between entities such as names of people, locations, and organizations.

Despite these techniques, a need exists for a method and system to formally describe a set of different plays in a holistic and uniform manner that can be used for database queries. Moreover, a need exists for techniques that recognize the distinction between conceptual models, interpretational assumptions, and observations and provide enhancements to the linking of these different aspects.

### SUMMARY

In one embodiment, a method that is used to analyze data representing a subsurface region for the presence of a hydrocarbon accumulation is described. The method may include defining a conceptual model of one or more subsurface hydrocarbon play concepts; defining an assertion model of one or more observations; defining an interpretational model having one or more interpretational assumptions and link one or more of the observations to one or more of the hydrocarbon play concepts; submitting a query for instances of one of the one or more hydrocarbon play concepts or classifying observations with regard to different concepts; and providing a report of the query results.

In one or more embodiments, the method may include different variations. For example, the one or more interpretational assumptions form the relationship between the one or more observations and the one or more hydrocarbon play concepts; are obtained from an interpreter sequentially in a series of assumptions to explore different scenarios; are obtained from an interpreter interactively making assumptions and interactively submitting queries; involve tagging or labeling one or more of the observations based on one or more hydrocarbon play concepts. Also, the one or more observations may include geologic attributes derived from seismic data; picking horizons and faults based on seismic data; wherein the one or more observations are based on one or more of seismic data, geophysical data, wireline data, and field analogues. Further, the one or more subsurface hydrocarbon play concepts include one or more of an anticline play, a normal-fault-trap play, a pinchout play and a salt-flank play.

In one or more embodiments, the method may include certain additional steps. For example, the query is formulated by a query agent and transmitted to a database storing one or more of the conceptual model, assertion model, and interpretational model. Also, the method may include displaying the report of the query results on a monitor; determining one or more leads based on the report of the query results or ranking the one or more leads based on estimated volume or minimal estimated risk.

In another embodiment, a system for analyzing data representing a subsurface region for the presence of a hydrocarbon accumulation is described. The system may include a processor; memory coupled to the processor; and a set of instructions stored in memory, accessible by the processor. The set of instructions when executed by the processor are configured to: define a conceptual model of one or more subsurface hydrocarbon play concepts; define an assertion model of one or more observations; define an interpretational model having one or more interpretational assumptions and link one or more of the observations to one or more of the hydrocarbon play concepts; submit a query for instances of one of the one or more hydrocarbon play concepts or classifying observations with regard to different concepts; and store a report of the query results. The set of instructions may also be configured to display the query results via a monitor.

These and other features and advantages of the present disclosure will be readily apparent upon consideration of the following description in conjunction with the accompanying drawings.

### BRIEF DESCRIPTION OF THE DRAWINGS

Advantages of the present techniques may become apparent upon reviewing the following detailed description and the accompanying drawings.

FIG. 1 is a conceptual model of elements of a hydrocarbon system for an anticlinal trap.

FIG. 2 is a schematic of a conceptual model for an anticline play.

FIG. 3 is a schematic of a conceptual model for a normal-fault-trap play.

FIG. 4 is a schematic of a conceptual model for a pinchout play.

FIG. 5 is a schematic of a conceptual model for a salt-flank play.

FIG. 6 is a diagram of observations, assumptions, and definitions in accordance of with an exemplary embodiment of the present techniques.

FIG. 7 is a flow diagram analyzing data representing a subsurface region in accordance with an exemplary embodiment of the present techniques.

FIG. 8 is a diagram of different components of a conceptual model for hydrocarbon accumulations in accordance with an exemplary embodiment of the present techniques.

FIG. 9 is an exemplary schematic of a sugar-cube or blocked model.

FIG. 10 is an exemplary schematic of a structure following grid.

FIG. 11 is an exemplary flow diagram of a query answer process in accordance of with an exemplary embodiment of the present techniques.

FIG. 12 is a diagram of an exemplary application of the play recognition method in accordance of with an exemplary embodiment of the present techniques.

FIG. 13 is a diagram of another exemplary application of the method in accordance of with an exemplary embodiment of the present techniques.

FIG. 14 is a block diagram of a computer system according to disclosed methodologies and techniques.

### DETAILED DESCRIPTION OF EXAMPLE EMBODIMENTS

Various terms as used herein are defined below. To the extent a term used in a claim is not defined below, it should be given the definition persons in the pertinent art have given that term in the context in which it is used.

As used herein, “a” or “an” entity refers to one or more of that entity. As such, the terms “a” (or “an”), “one or more”, and “at least one” can be used interchangeably herein unless a limit is specifically stated.

As used herein, the terms “comprising,” “comprises,” “comprise,” “comprised,” “containing,” “contains,” “contain,” “having,” “has,” “have,” “including,” “includes,” and “include” are open-ended transition terms used to transition from a subject recited before the term to one or more elements recited after the term, where the element or elements listed after the transition term are not necessarily the only elements that make up the subject.

As used herein, “exemplary” means exclusively “serving as an example, instance, or illustration.” Any embodiment described herein as exemplary is not to be construed as preferred or advantageous over other embodiments.

As used herein “hydrocarbons” are generally defined as molecules formed primarily of carbon and hydrogen atoms such as oil and natural gas. Hydrocarbons may also include other elements or compounds, such as, but not limited to, halogens, metallic elements, nitrogen, oxygen, sulfur, hydrogen sulfide (H2S) and carbon dioxide (CO2). Hydrocarbons may be produced from hydrocarbon reservoirs through wells penetrating a hydrocarbon containing formation. Hydrocarbons derived from a hydrocarbon reservoir may include, but are not limited to, petroleum, kerogen, bitumen, pyrobitumen, asphaltenes, tars, oils, natural gas, or combinations thereof. Hydrocarbons may be located within or adjacent to mineral matrices within the earth, termed reservoirs. Matrices may include, but are not limited to, sedimentary rock, sands, silicilytes, carbonates, diatomites, and other porous media.

As used herein, “hydrocarbon production” or “producing hydrocarbons” refers to any activity associated with extracting hydrocarbons from a well or other opening. Hydrocarbon production normally refers to any activity conducted in or on the well after the well is completed. Accordingly, hydrocarbon production or extraction includes not only primary hydrocarbon extraction but also secondary and tertiary production techniques, such as injection of gas or liquid for increasing drive pressure, mobilizing the hydrocarbon or treating by, for example chemicals or hydraulic fracturing the wellbore to promote increased flow, well servicing, well logging, and other well and wellbore treatments.

As used herein, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and/or a computer. One or more computer components can reside within a process and/or thread of execution and a computer component can be localized on one computer and/or distributed between two or more computers.

As used herein, the terms “computer-readable medium” or “tangible machine-readable medium” refer to any tangible non-transitory storage that participates in providing instructions to a processor for execution. Such a medium may take many forms, including but not limited to, non-volatile media, and volatile media. Non-volatile media includes, for example, NVRAM, or magnetic or optical disks. Volatile media includes dynamic memory, such as main memory. Computer-readable media may include, for example, a floppy disk, a flexible disk, hard disk, magnetic tape, or any other magnetic medium, magneto-optical medium, a CD-ROM, any other optical medium, a RAM, a PROM, and EPROM, a FLASH-EPROM, a solid state medium like a holographic memory, a memory card, or any other memory chip or cartridge, or any other physical medium from which a computer can read. When the computer-readable media is configured as a database, it is to be understood that the database may be any type of database, such as relational, hierarchical, object-oriented, and/or the like. Accordingly, exemplary embodiments of the present techniques may be considered to include a tangible storage medium or tangible distribution medium and prior art-recognized equivalents and successor media, in which the software implementations embodying the present techniques are stored.

Some portions of the detailed description which follows are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions using the terms such as “modeling”, “modifying”, “measuring”, “comparing”, “determining”, “analyzing”, “outputting”, “displaying”, “estimating”, “integrating”, or the like, refer to the action and processes of a computer system, or similar electronic computing device, that transforms data represented as physical (electronic) quantities within the computer system's registers and memories into other data similarly represented as physical quantities within the computer system memories or registers or other such information storage, transmission or display devices. Example methods may be better appreciated with reference to flow diagrams.

While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various serially occurring actions, it is to be appreciated that various actions could occur concurrently, substantially in parallel, and/or at substantially different points in time.

In the following section, specific embodiments of the disclosed methodologies and techniques are described in connection with disclosed aspects and techniques. However, to the extent that the following description is specific to a particular aspect, technique, or a particular use, this is intended to be for exemplary purposes only and is not limited to the disclosed aspects and techniques described below, but rather include all alternatives, modifications, and equivalents falling within the scope of the appended claims.

This present disclosure involves a system and method for determining the location of hydrocarbons in an enhanced manner. The present techniques provides a method and system for formally describing a set of different plays in a holistic and uniform manner that can be used for database queries. Further, the present techniques provide a method and system that recognizes the distinction between conceptual models, interpretational assumptions, and observations. In particular, specific plays are examples of conceptual models, while seismic data as well as other geologic data are observations that are subject to interpretation as evidence for specific instances of conceptual models. The assumptions are typically needed to link observations with the concepts (e.g., one or more subsurface hydrocarbon play concepts in the conceptual model). The present techniques provide a mechanism to manage the concepts, observations and the assumptions needed link observations to concepts.

The present techniques provides a method and system that assist the interpreter in analyzing seismic, geophysical, or geoscience data for the presence of elements of the hydrocarbon system, flags regions where play elements are juxtaposed in potential configurations (e.g., configurations that may potentially hold hydrocarbons) or consistent with a known or specified play, and provides a mechanism to rank these leads with regard to their hydrocarbon accumulation potential. To construct such a system, a method is needed to define favorable configurations or specific plays, and then to use these definitions to query databases for locations where these definitions are satisfied. Some of these definitions may be quite objective, while others may be more subjective and specified by the interpreter. The present techniques satisfy at least these needs. In some embodiments, the interpreter further queries the system as to why a specified location was flagged or not flagged. In some embodiments, the interpreter changes definitions in response to an unexpected query results.

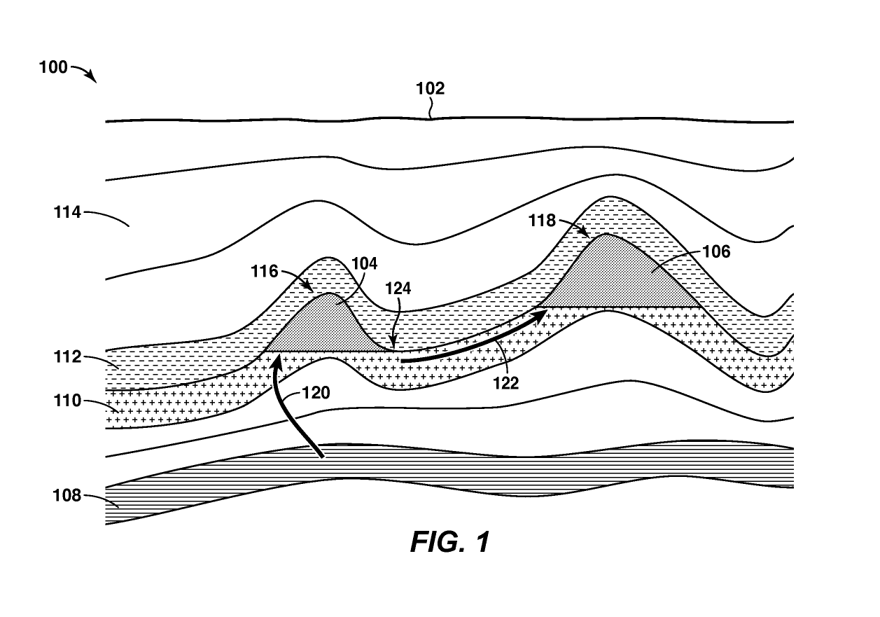

In one or more embodiments, a method for analyzing data representing a subsurface region for the presence of a hydrocarbon accumulation or a particular play is described. The method, which may be computer implemented, may include defining a conceptual model of subsurface hydrocarbon accumulations (e.g., conceptual model of one or more subsurface hydrocarbon play concepts); defining an interpretational model linking observations to concepts; obtaining and entering observations into a database; querying the database for instances of particular concepts or classifying observations with regard to different concepts; and repetition of the above steps for additional iterations. For certain embodiments, a computer may include code or a set of instructions that are stored in memory and when executed by a processor, select at least one computer algorithm that generates observations and stores the observations into a database and may also present the observations through a display (e.g., provide a visualization of the observations). Further, an interpreter may specify at least one set of analysis units and observations that are related to individual analysis units. Also, the analysis units that succeed with regard to one query may be highlighted in a display and the sets of query results may be rated and ranked. Various aspects of the present techniques are described further in FIGS. 1 to 14.

Although the term may be used more broadly or narrowly elsewhere, a petroleum or hydrocarbon system is generally used herein to mean a natural system that encompasses a pod of active source rock and the related oil and gas. It includes the geologic elements and processes that form a hydrocarbon accumulation, as illustrated in FIG. 1. FIG. 1 illustrates exemplary elements of a hydrocarbon system 100 for an anticlinal trap formed under a surface 102 of the Earth. The hydrocarbons identified in nature include high concentrations of thermal and/or biogenic gas, found in conventional reservoirs or in gas hydrates, tight reservoirs, fractured shale, or coal; and condensates, crude oils, heavy oils, asphalts and tars. The term “system” describes the interdependent elements and processes that form the functional unit that creates hydrocarbon accumulations, such as hydrocarbon accumulations 104 and 106. The elements include a source rock 108, reservoir rock 110, seal rock 112, and overburden rock 114. The processes are the formation of the traps (e.g., traps 116 and 118) and the maturation, migration (e.g., via migration paths 120 and 122), and accumulation of hydrocarbons leading to a hydrocarbon charge in a sealed trap, such as hydrocarbon accumulations 104 and 106. The processes involve a sequence or timing of events that may extend over long periods of time.

An alternate definition of the hydrocarbon system 100 may include only the source rock, the processes of maturation and migration, and their timing; in this case, reservoir, seal, and trap may be defined to form a play. For the purpose of explaining the present techniques, the term hydrocarbon system is defined to cover source, reservoir, seal, trap, charge, maturation, migration, accumulation and timing. Furthermore, the term play is generally used herein to denote a specific combination and arrangement of reservoir, seal, and trapping geometry, instances of which are play elements.

Source, such as source rock 108, is a rock rich in organic matter which, if heated sufficiently, generates oil and/or gas over time. Common source rocks include shales or limestones. Rocks of marine origin tend to be oil-prone, whereas terrestrial source rocks (such as coal) tend to be gas-prone. Preservation of organic matter without degradation is requirement to creating source rock, and utilized for a hydrocarbon system. The element of source may be split into two components: source presence and source quality. For the purposes of the present techniques, the term source is used broadly to denote source presence and/or source quality, and combinations thereof.

Reservoir, such as reservoir rock 110, is a subsurface body of rock having sufficient porosity and permeability to receive, store, and transmit fluids. Sedimentary rocks are the most common reservoir rocks because they have more porosity than igneous and metamorphic rocks and form under temperature conditions at which hydrocarbons can be preserved. The element of reservoir may be split into two components: reservoir presence and reservoir quality. For the purpose of the present techniques, the term reservoir is used broadly to denote reservoir presence and/or reservoir quality, and combinations thereof.

Seal, such as seal rock 112, is a relatively impermeable rock, commonly shale, anhydrite, or salt, which forms a barrier or cap above and partially around reservoir rock such that fluids cannot migrate beyond the reservoir rock.

Overburden, such as overburden rock 114, is the rock on top of the source rock and reservoir rock. In context of the hydrocarbon system, its main function is to form a thick blanket over the source where it increases temperature and pressure to the degree necessary to convert organic matter to hydrocarbons.

Trap, such as traps 116 and 118, is a configuration of rocks suitable for containing hydrocarbons and sealed by a relatively impermeable formation through which hydrocarbons do not migrate. Traps are described as structural traps (in deformed strata such as folds and faults) or stratigraphic traps (in areas where rock types change, such as unconformities, pinchouts and reefs) or combinations thereof. For structural traps, deformation occurs before hydrocarbon migration, or the hydrocarbons do not accumulate.

Generation or maturation is the formation of hydrocarbons from a source rock as bitumen forms from kerogen and accumulates as oil or gas. Generation depends on three main factors: the presence of organic matter rich enough to yield hydrocarbons, adequate temperature, and sufficient time to bring the source rock to maturity. Pressure and the presence of bacteria and catalysts also affect generation. Insufficient pressure and temperature, caused for example by a shallow burial with a thin overburden, renders a source immature and generation is lacking or incomplete. Excessive pressure and temperature, caused for example by deep burial under a thick overburden, causes degradation of generated oil to gas and subsequently to carbon dioxide and water. Generation is one of the main phases in the development of a hydrocarbon system.

Migration is the movement of hydrocarbons from their source rocks into reservoir rocks. The movement of generated hydrocarbons out of their source rock is primary migration, also called expulsion. The further movement of the hydrocarbons into reservoir rock in a hydrocarbon trap or other area of accumulation is secondary migration. Migration typically occurs from a structurally low area to a higher area because of the relative buoyancy of hydrocarbons in comparison to the surrounding rock. Migration can be local or can occur along distances of hundreds of kilometers in large sedimentary basins and is critical to the formation of a viable hydrocarbon system. As an example, the hydrocarbons may migrate from the source rock 108 along a first migration path 120 to the reservoir rock 110 in trap 116. Then, the hydrocarbons may migrate from the spill point 124 along a second migration path 122 to the reservoir rock 110 in the second trap 118.

Accumulation refers both to an occurrence of trapped hydrocarbons (e.g., a play or an oil or gas field), and to the phase in the development of a hydrocarbon system during which hydrocarbons migrate into and remain trapped in reservoir rocks. For the purpose of the present techniques, the term charge is used to specifically denote a pool of hydrocarbons, such as hydrocarbons 104 and 106. Naturally, a subsurface pool of hydrocarbon is typically sealed in and trapped, originated from a source, and maturation and migration have occurred. In other words, the very existence of a subsurface pool of hydrocarbons typically demonstrates that the hydrocarbon system elements are present. For the purpose of the present techniques, charge solely denotes a pool of hydrocarbons without implying the presence of a working hydrocarbon system because the system of the present techniques integrates remotely sensed observations into a prediction. The remote sensing methods cannot really identify a hydrocarbon pool or charge but rather detect evidence thereof that may be circumstantial. Seismic evidence is often called a direct hydrocarbon indication. The system of the present techniques relies on inputted data to detect, predict or estimate the presence of individual hydrocarbon system elements. These element predictions are then used within the disclosed system to detect, predict or estimate the presence of a hydrocarbon reservoir or the presence of a specific hydrocarbon play.

Timing refers to the relative order in which elements are formed or modified, or the order in which processes occur. A trap can accumulate migrating hydrocarbons only if it is formed before migration. A trap may be unfilled if migration has not yet reached its location. A trap may lose its charge, at least partially, if the seal is breached after accumulation.

A play is a conceptual model for a style of hydrocarbon accumulation often used to develop prospects in a basin, region or trend or used to continue exploiting an identified trend. A play (or a group of interrelated plays) generally occurs in a single hydrocarbon system and may be comprised of a group of similar prospects.

A prospect is an area, such as the area in traps 116 and 118, in which hydrocarbons have been predicted to exist. A prospect is often an anomaly, such as a geologic structure or a seismic amplitude anomaly, which is recommended as a location for drilling a well to ascertain economic quantities of hydrocarbons. Justification for drilling a prospect is made by assembling evidence for an active hydrocarbon system, or demonstrating reasonable probabilities of encountering good quality reservoir rock, a trap of sufficient size, adequate sealing rock, appropriate conditions and timing for generation and migration of hydrocarbons to fill the reservoir, and one or more geophysical indications for hydrocarbons or charge.

Lead is used to denote an area that is determined to be a potential location of hydrocarbons. Given further analysis, a lead may be matured into a prospect. For the purpose of the present techniques, lead and prospect are often used somewhat interchangeably.

Prospectivity is a prospect or lead predictor based on indications of multiple hydrocarbon system elements. Prospectivity is a measure or estimate of the probability of encountering reservoir rock having properties that support hydrocarbon accumulations, a sizeable trap, adequate seal, source rock, overburden leading to appropriate conditions for generation and migration of hydrocarbons to fill the reservoir, timing of these processes, and one or more geophysical indications for hydrocarbons or charge.

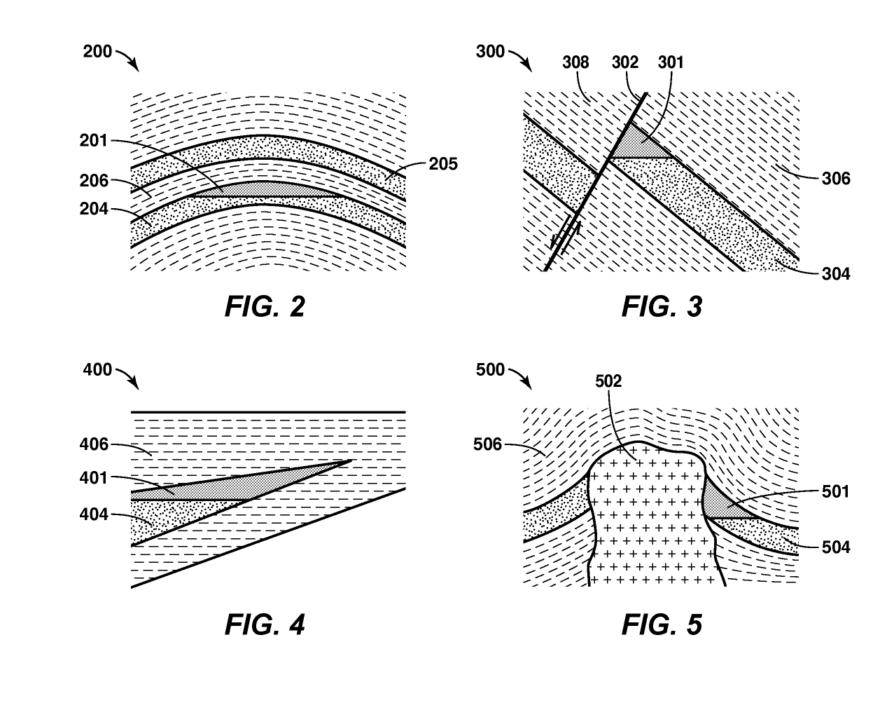

Examples of different plays are provided in FIGS. 2 to 5. The examples are used first to demonstrate the need for formal definitions or conceptual models. Second, the examples are used to teach aspects of forming and working with conceptual models. Lastly, the examples are used in exemplary application as targets to be identified and located in seismic data. To begin, the conceptual model of an anticline play is shown in

FIG. 2, which is a schematic of a conceptual model 200 for an anticline play. The model 200 defines an anticline play along the line of an anticline with a sand layer 204 beneath a shale layer 206, which traps hydrocarbons 201 in the sand layer 204. The dashed zones, such as shale layer 206, are shale layers, while the dotted zones, such as sand layer 204, are sand layers.

As another example, FIG. 3 is a schematic of a conceptual model 300 for a normal-fault-trap play. The model 300 defines a normal-fault-trap play along the line of a fault 302 with a sand layer 304 beneath shale layers 306 and 308, which traps hydrocarbons 301 in the sand layer 304. The dashed zones, such as shale layers 306 and 308, are shale layers, while the dotted zones, such as sand layer 304, are sand layers and the fault, such as fault 302, is the black diagonal line.

As yet another example, FIG. 4 is a schematic of a conceptual model 400 for a pinchout play. The model 400 defines a pinchout play formed from a shale layer 406 at least partially enclosing a sand layer 404, which traps hydrocarbons 401 in the sand layer 404. The dashed zones, such as shale layer 406, are shale layers, while the dotted zones, such as sand layer 404, are sand layers.

As a final example, FIG. 5 is a schematic of a conceptual model 500 for a salt-flank play. The model 500 defines a salt flank play formed a salt layer 502 thrusting up into a sand layer 504 and a shale layer 506, which traps hydrocarbons 501 in the sand layer 504. The dashed zones, such as shale layer 506, are shale layers, while the dotted zones, such as sand layer 504, are sand layers and the plus-marked zone, such as salt layer 502, is a salt layer.

While the sketches appear to be intuitive, each of these models relies upon a series of assumptions. The series of assumptions include an assumption about scale and dimensionality of the play, and/or the properties of sand and shale. As an example, this interpretation of the anticline play model 200 relies upon a series of assumptions, which may include an assumption about scale and dimensionality of the play, and/or the properties of sand and shale. These assumptions may be subject to further interpretation. That is, the overall concept shown in these conceptual models may be agreed upon by different interpreters, while the specific details within the models may be subject to diverse interpretations, even for these simple examples. In fact, increasing the complexity may involve more assumptions, which may increase the potential for disagreement and inconsistencies between interpretations. The anticline play model 200 also exhibits ambiguities. The sketch contains two dotted zones indicating two sands (zones 204 and 205): does an anticline play require two sands or does the sketch demonstrate two anticline plays? Only sand 204 contains hydrocarbons 201: is the presence of hydrocarbons a necessary condition in the definition of an anticline play? This aspect is further compounded by the use of computer systems that are unable to parse the sketches or fill in the underlying assumptions. A human interpreter may be able to see through these ambiguities, but a computer system built on digital logic will require further clarification or formalization.

Accordingly, to define plays and other concepts in a manner that can be parsed and processed with a computer, a method and system are utilized to manage the distinction and relationships between conceptual models, interpretational assumptions, and observations. To construct such a system, favorable configurations or specific plays should be defined, observations should be made and entered into databases, and then these definitions should be used to query databases for locations where these definitions are satisfied in light of observations and assumptions. Some of these definitions may be quite objective, while others may be more subjective and specified by the interpreter. In system, the interpreter may make further queries to the system as to why a specified location was flagged or not flagged and/or the interpreter may also change definitions in response to an unexpected query results. Further, the conceptual model may include one or more subsurface hydrocarbon play concepts (e.g., the conceptual models of FIGS. 2 to 5).

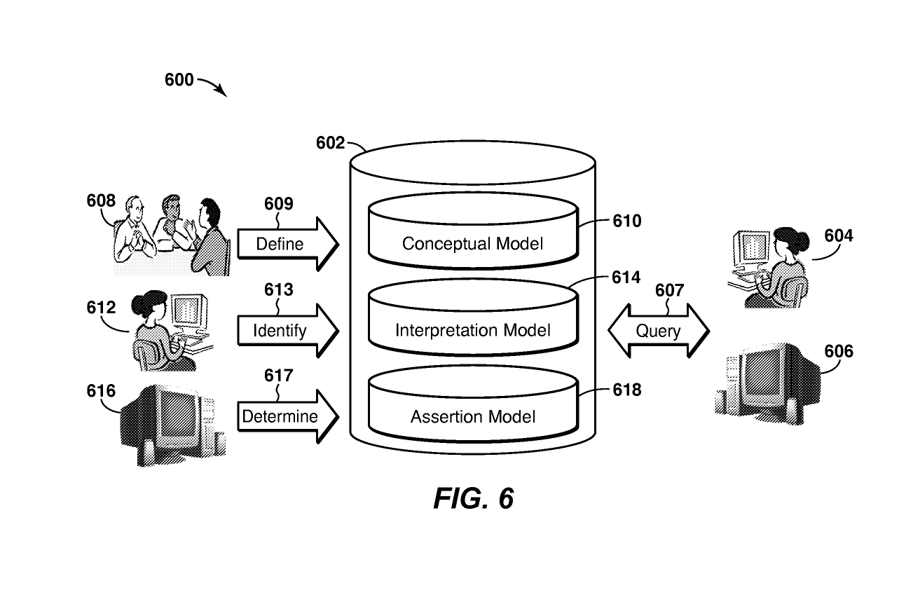

As an example, FIG. 6 is a diagram 600 of observations, assumptions, definitions, and the processes of generating and using them in accordance with an exemplary embodiment of the present techniques. This diagram 600 includes observations, assumptions, and definitions stored in a repository 602, which may be accessed to obtain results to one or more queries from interpreters 604 or a query agent 606, which may be a computer system. The repository 602 may be a database, memory or other suitable storage device that may be accessed to obtained the stored data.

In this diagram 600, an interpreter or more typically a group of experts 608, defines a first model or a conceptual model 610 that specifies the elements of the hydrocarbon system and plays as well as their relationships, as shown in block 609. One or more conceptual models may be defined and stored in the repository 602, wherein the conceptual model may include one or more subsurface hydrocarbon play concepts. Because the models are conceptual, updates and changes are expected to be relatively limited (e.g., merely bug fixes and incremental evolution of understanding of the underlying domain). However, a paradigm shifts in the fundamental understanding of the domain may involve an update to one or more of the conceptual models. The conceptual model is formalized in a manner that can be parsed by the computer and entered into memory via input devices and stored in a database.

To store observations, an agent 616 analyses data to determine or make observations and to enter the observations into the repository 602 and to store the observations into the assertion model 618, as shown in block 617. The agent 616 may preferably be a computer algorithm stored in memory as a set of instructions, which is accessible by a processor and when executed is configured to perform the set of instructions. However, the agent 616 may also include an interpreter interfacing with the repository 602 and/or a combination of both. The observations may be stored or arranged into a second model or assertion model 618, which is stored in the repository 602.

To link the observations to the conceptual model, an interpreter 612 identifies one or more assumptions that form the relationship between observations and the conceptual model, which is shown in block 613. This link is in the form of a third model or interpretation model 614 that contains the interpretational assumptions. The interpretation model is also entered into the repository 602. In some embodiments of the present techniques, the interpreter or a group of interpreters may specify the assumptions one time and/or different interpreters may provide and store different assumptions within the model. In one or more embodiments, the interpreter may sequentially enter a series of assumptions to explore different scenarios or may interactively enter assumptions and interactively perform queries to locate plays.

To perform a query, the interpreter 604 and/or the query agent 606 may access the combined database, such as the repository 602, for occurrences of specified concepts based on the observations or for a list of concepts compatible with a specified set of observations, as shown in block 607. For many queries, a gap between concepts and observations may be present. This gap may be a result of the conceptual model being a high-level model that abstracts and idealizes much detail, while the observations are predominantly specific details. To bridge this gap, the observations and interpretations may be blended. However, the risk of the blending is that the observations should be objective, while interpretations can be subjective. Thus the need for the third model, the interpretational model or the assumptions that separates observations from concepts.

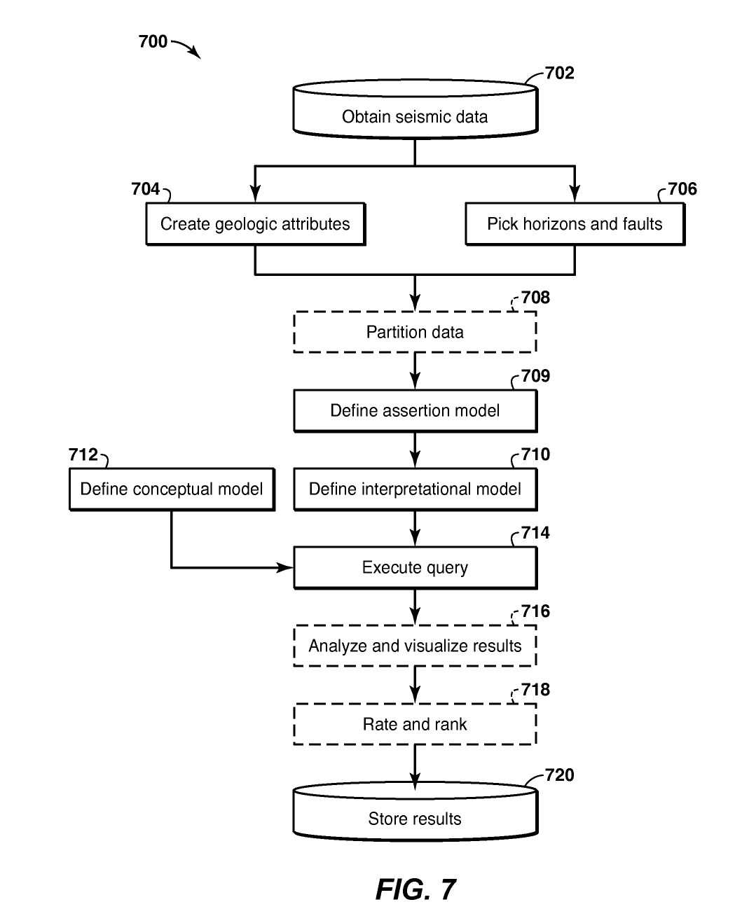

Beneficially, the present techniques provides a method and system that assist the interpreter in analyzing seismic, geophysical, or geoscience data for the presence of elements of the hydrocarbon system, flags regions where play elements are juxtaposed in potential configurations (e.g., configurations that may potentially hold hydrocarbons) or consistent with a known or specified play, and provides a mechanism to rank these leads with regard to their hydrocarbon accumulation potential. This aspect is further described with reference to FIG. 7.

FIG. 7 is a flow diagram related to the analysis of data representing a subsurface region in accordance with an exemplary embodiment of the present techniques. In this flow diagram 700, a model building stage is performed in blocks 702 to 712, while a query stage is performed in blocks 714 to 720.

The method begins with the model building stage in blocks 702 to 712. In block 712 the conceptual model is defined. The definition of the conceptual model may include defining the domain of hydrocarbon systems, hydrocarbon plays, and other domains as necessary. The conceptual model is specified in a formal manner that can be entered and stored in a database and parsed (e.g., searched by a computer algorithm or set of instructions).

At block 702 seismic data may be obtained and stored. The seismic data may be stored in the form of a seismic model, a seismic volume and/or a group of seismic traces. At blocks 704 and 706, various observations are determined and stored into a database. In particular, geologic attributes (closure, seismic texture, amplitude, fault probabilities, etc.) may be created from the seismic data, as shown in block 704, while horizons and faults may be picked from the seismic data, as shown in block 706. While these observations are described as being based on seismic data, the observations may also include other data, such as geophysical data, wireline data, field analogues, etc. Observations are tagged and labeled based on concepts from the conceptual model. As an example, one preferred embodiment may include making observations on seismic data through the use of seismic or geologic attributes and/or making observations through interpretation, such as picking horizons or faults. These observations may be organized into an assertion model as shown in 709. In one exemplary application, attributes such as closure, amplitude, and seismic texture are computed by an agent and automatically added into the assertion model. An interpreter picks faults and the edges of salt bodies using traditional techniques and an agent enters these traditional observations into the assertion model, as shown in block 709.

The subsurface data may optionally be partitioned into smaller units of analysis, as shown in block 708. While observations may be made within some frame of reference, many observations are spatially extended and often have somewhat fuzzy boundaries or shapes, which can make exact specification of coordinates challenging. Instead, some or all observations may be pinned to analysis units or partitions. In other words, observations may at least be partially contained within individual partitions. Accordingly, multiple partitioning schemes, which overlap in some places, may be utilized to provide scale-dependent analysis. The partitioning is also entered into the assertion model 709.

At block 710, an interpretational model is defined. In an exemplary application, an interpreter may believe that a particular seismic texture corresponds to sand prone rocks, while another seismic texture corresponds to shale prone rocks. The interpreter enters these believes into the interpretational model as if they were part of the conceptual model, but because they are stored in a separate part of the database or at last marked as being part of the interpretational model, they are clearly distinguishable from conceptual model or assertions. The definition of the interpretation model may be a formal specification of interpretational assumptions that are entered into a database. In a preferred embodiment, the interpreter may enter, modify, and delete the interpretational model interactively, while querying the database.

After the model building stage is performed, a query stage is performed in blocks 714 to 720. At block 714 a query is executed. A query may be formulated by a query agent and transmitted to the database. Then, the results of the query may be transmitted to the query agent. With the query results obtained, the results may optionally be visualized and analyzed, as shown in block 716. In an exemplary application, an agent requests a list of all locations where the observations are compatible with the conceptual model for an anticline play. The visualization and analysis of the results may be performed to identified leads, plays, or play elements. At block 718, the leads from the visualization and analysis and/or the query may optionally be rated and ranked. That is, at least some of the identified leads may be prioritized. As an example, some leads may provide larger hydrocarbon accumulations, may involve less risk, or may have lower uncertainty due to the amount and quality of data. Based on these and other criteria, the identified leads are rated and ranked, which may be a subjective scale determined by the interpreter or a set of instructions. Regardless, the identified leads, query results, leads and/or other results may be stored in memory, as shown in block 720. The memory may be the memory of a computer system and/or a database, which may be accessed for further analysis.

In these embodiments, a model is any organization of data that represents data associated with the subsurface region. A conceptual model, as exemplified above in FIGS. 2 to 5, is used to assist the interpreter understand the subsurface region in terms of what concepts exist at a relatively high level and how different concepts relate to each other or how they define each other. Conceptual models are used to understand the subject matter they represent. They are formed after a conceptualization process in the mind and represent human intentions or semantics (meaning). Concepts are often used to convey semantics during natural-language based communication. Since a concept might map to multiple semantics, an explicit formalization is usually required for identifying and locating the intended semantic from several candidates to avoid misunderstandings and confusion in the concept.

One method of formalizing a conceptual model is through the use of an ontology. An ontology formally represents knowledge as a set of concepts within a domain, and the relationships among those concepts. It can be used to reason about the entities within that domain and may be used to describe the domain. That is, an ontology is a formal, explicit specification of a shared conceptualization. An ontology renders shared vocabulary and taxonomy, which models a domain with the definition of objects and/or concepts and their properties and relations.

Specifically, ontologies contain explicit definitions of terms used by agents, which may be used to refer to interpreters, algorithms, or set of instructions or code that act on behalf of a user or another program. Ontologies provide unambiguous interpretation of terms and their meaning because their semantics are expressed as constructs in a formal language such as first order description logic. The intent of having an ontology shared between agents when used puts an emphasis on shared development, too. Many ontologies are developed for use with reasoning agents that can deduce new facts from existing concepts, definitions, or assertions by systematic examination of the statements. An ontology is an explicit description of a domain that contains concepts, properties and attributes of concepts, constraints on properties and attributes, and individual instances of concepts. For the purpose of this disclosure, the terms individual instance, individual, and instance are used interchangeably. In the present techniques, the ontology domain is related to hydrocarbon accumulations and associated fields. Thus, ontologies define common vocabulary and shared understanding to provide the reuse of domain knowledge, introducing standards and a structured format to reduce or minimize reworking similar aspects. Further, ontologies may be utilized to separate domain knowledge from operational knowledge.

One of the features of ontologies is that they make domain assumptions explicit. While interpreters may disagree with some domain assumptions or concepts, at least every agent parsing the ontology complies and knows what assumptions were made. Every agent parsing an ontology should deduce the same conclusions. An internally inconsistent ontology may result in contradictory deductions. Because the assumptions are explicitly stored in memory and associated with the ontology, the assumptions are understandable and may be changed and maintained in a consistent manner. In preferred embodiments, block 710 enables an individual agent to impose his own assumptions or interpretational rules. Block 710 may be seen as a local or temporary extension of the base conceptual model shown in block 712.

Ontologies are a type of structural framework for organizing information and are used in artificial intelligence, the semantic web, systems engineering, software engineering, biomedical informatics, library science, enterprise bookmarking, and information architecture as a form of knowledge representation about the world or some part of it. The ontology describes how such data can be grouped, related within a hierarchy, and subdivided according to similarities and differences.

Related to ontologies, a domain model is created to represent the vocabulary and key concepts of the identified domain. The domain model also identifies the relationships among the entities within the scope of the identified domain, and commonly identifies their attributes. The domain model describes and constrains the scope of the identified domain. The domain model can be effectively used to verify and validate the understanding of the identified domain among various stakeholders. It defines a vocabulary and is helpful as a communication tool and may add precision and focus to discussion among the interpreters as well as between the interpreters and business personnel. For the purpose of the present disclosure, the terms domain model and ontology are used interchangeably.

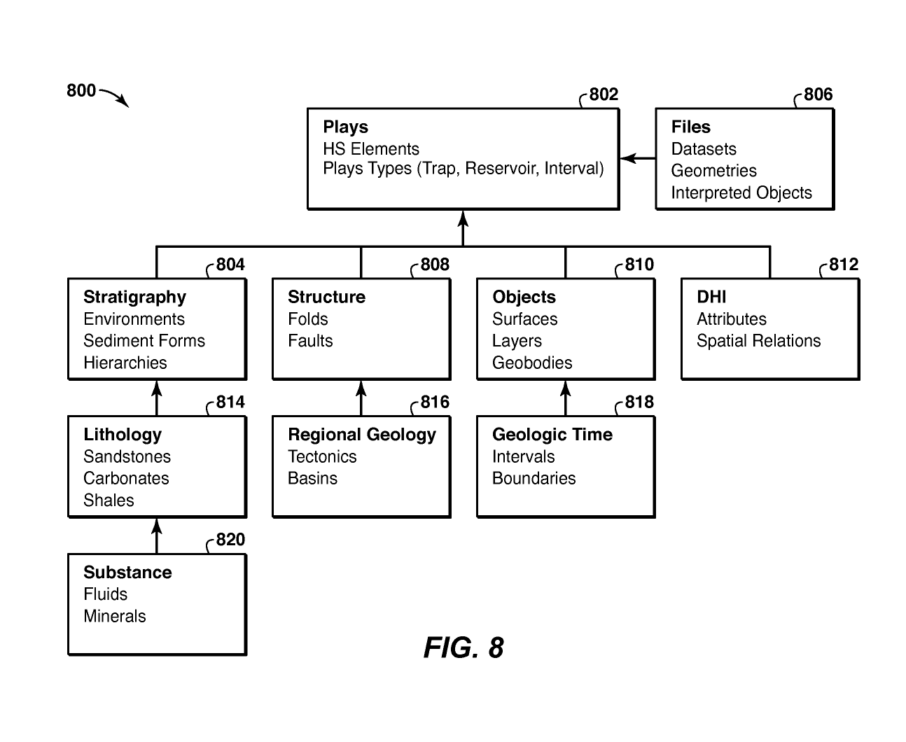

As an example, the defining of the conceptual model, as noted in block 712, may be further explained as it relates to ontology and as shown in FIG. 8. In this example, a user or a group of domain experts construct the conceptual model for the domain of hydrocarbon accumulations and related fields. This conceptual model is the core ontology and may define concepts and relations in the fields of mineralogy, lithology, stratigraphy, structural geology, regional geology, tectonics, geologic time or hydrocarbon plays. For the present techniques, additional ontologies may be created to describe geometry, files, data types, grids, or partitions; and geological and geophysical attributes, and interpretation artifacts such as surfaces, horizons, fault sticks, geobodies, and layers.

FIG. 8 is a diagram 800 of different components of a conceptual model for hydrocarbon accumulations in accordance with an exemplary embodiment of the present techniques. In this FIG. 8, some of the components 802 to 820 utilized in the conceptual model or hydrocarbon-accumulation ontology are further described. The defining of the conceptual model may include determining scope, enumerating terms, defining concepts, defining properties and relations between concepts, defining constraints, and generating validation instances. In the exemplary application, the conceptual model contains components 802 to 820 that define concepts relating to plays, play types and elements thereof, stratigraphy, geologic time, structural elements such as folds and faults, objects such as geobodies and surfaces, different rock types and the minerals that form the different rock types, or auxiliary entities such as file systems, file types, authors, and timestamps.

The resulting ontology may be formally expressed using first order description logic, or preferably using a knowledge representation language such as the Web Ontology Language, OWL (http://www.w3.org/TR/owl2-overview). An excerpt from the definition of an anticline play (as depicted in

FIG. 2) expressed in the OWL language is presented in Table 1.

TABLE 1
presents an excerpt of a formal definition of an Anticline play.

| | |
|---|---|
| 1. | ClassAssertion( :FoldShape :AntiShape ) |
| 2. | ClassAssertion( :FoldShape :SynShape ) |
| 3. | SubClassOf( :AnticlineFold :Fold ) |
| 4. | EquivalentClasses( :AnticlineFold ObjectHasValue( :hasFoldShape |
| | :AntiShape ) ) |
| 5. | SubClassOf( :SandLayer :Layer ) |
| 6. | SubClassOf( :ShaleLayer :Layer ) |
| 7. | SubClassOf(:SealedSandPlay :Layer) |
| 8. | EquivalentClasses( :SealedSandLayer ObjectIntersectionOf( |
| | ObjectSomeValuesFrom( :isDirectlyBelow: ShaleLayer ) :SandLayer ) ) |
| 9. | SubClassOf( :AnticlinePlay :Play ) |
| 10. | EquivalentClasses( :AnticlinePlay |
| | ObjectIntersectionOf( :SealedSandLayer :AnticlineFold ) ) |
| 11. | ClassAssertion( :SeismicFacies |
| | :HighAmplitudeContinuousSeismicFacies ) |
| 12. | ClassAssertion( :SeismicFacies :TransparentSeismicFacies ) |
| 13. | ClassAssertion( :SeismicFacies |
| | :MediumAmplitudeSemiContinuousSeismicFacies ) |

Lines 1 and 2 of Table 1 define that ‘AntiShape’ and ‘SynShape’ are members or elements of the ‘FoldShape’ concept. Line 3 of Table 1 defines that an ‘AnticlineFold’ is a specific type of ‘Fold’. Line 4 of Table 1 defines that elements that exhibit a ‘hasFoldShape’ property of ‘AntiShape’ are defined to belong to the ‘AnticlineFold’ concept. Lines 5, 6 and 7 of Table 1 define that ‘SandLayer’, ‘ShaleLayer’, and ‘SealedSandLayer’ are specific types of ‘Layers’. Line 8 of Table 1 defines an element that is of type ‘SandLayer’ and that has the property ‘isDirectlyBelow some ShaleLayer’ to be a ‘SealedSandLayer’. Line 9 of Table 1 defines that an ‘AnticlinePlay’ is a specific ‘Play’. Line 10 of Table 1 defines an element that is both a member of the ‘SealedSandLayer’ concept and the ‘AnticlineFold’ concept to be a member of the ‘AnticlinePlay’ concept. Lines 11 to 13 of Table 1 define that ‘FlighAmplitudeContinuousSeismicFacies’, ‘TransparentSeismicFacies’, and ‘MediumAmplitudeSemiContinuous SeismicFacies’ are members of the ‘SeismicFacies’ concept. For the sake of brevity, many concepts (‘FoldShape’, ‘Fold’, ‘Layer’, ‘Play’, ‘SeismicFacies’) have been omitted from the excerpt of Table 1. In a practical ontology, these concepts may also be defined. It often becomes impractical to define each and every concept in terms of other concepts. Instead, some concepts are simply asserted to exist or differ from other concepts without further specification.

In the above definitions, the definitions for ‘SandLayer’ and ‘ShaleLayer’, where not defined because the presence of sand or shale is often not directly observed on seismic data but rather inferred. To differentiate or distinguish sand and shale, the interpreter may use seismic impedance data, may use seismic amplitude data, and/or may use seismic facies to distinguish sand from shale (e.g., as described in U.S. Pat. No. 6,560,540).

In block 710, the interpreter defines the interpretational model that specifies assumptions linking observations to concepts. The conceptual model, which is formed in block 712, and the interpretational model, which is formed in block 710, are separate models because the conceptual model captures the essence of the domain, while the interpretation model contains the working assumptions utilized to search for leads in one dataset or region. An excerpt of the interpretational model is presented in Table 2

TABLE 2
presents an excerpt of an interpretational model.

| | |
|---|---|
| 14. | EquivalentClasses( :SandLayerObjectHasValue( :hasFacies |
| | :HighAmplitudeContinuousSeismicFacies ) ) |
| 15. | EquivalentClasses( :ShaleLayer ObjectHasValue( :hasFacies |
| | :TransparentSeismicFacies ) ) |

On Line 14 of Table 2, the interpreter defines a ‘SandLayer’ to be an element that exhibits the ‘hasFacies’ property of ‘FlighAmplitudeContinuousSeismicFacies’, while Line 15 defines a ‘ShaleLayer’ as an element that exhibits the ‘hasFacies’ property of ‘TransparentSeismicFacies’.

In a preferred embodiment of the present techniques, an agent defines the interpretational model (e.g., block 710), performs a query (e.g., block 714), and analyzes the query returns, for example by visualization (e.g., block 716). In response to the analysis of the returned query (e.g., results), the agent modifies the interpretational model by deleting, changing, and/or adding some assumptions. The interpreter may, for example, augment the definition of a ‘SandLayer’ (Line 14) to exhibit either the ‘hasFacies’ properties of ‘HighAmplitudeContinuousSeismicFacies’ or ‘MediumAmplitudeSemiContinuousSeismicFacies’. Blocks 710, 714 and 716 are repeated until some specified criteria are satisfied.

Then, the observations made by an agent, preferably a computer algorithm operating on data (e.g., block 704), may be utilized. The data may include seismic data, seismic attributes, other geophysical data, or wireline data. In a preferred embodiment of the present techniques, a computer algorithm analyses seismic attributes and provides the results into a database or assertion model. Many such attributes have been disclosed and are known by those skilled in the art, such as Intl. Application No. 2011149609. Observations may be individual values, geobodies obtained after thresholding, or in a preferred embodiment, some statistical property of attribute values contained within a specified region. For the purpose of describing the present techniques, a geobody is simply a set of cells in a geologic model or a set of samples in a seismic dataset. These values, a statistical property of the values, or a discretization of values or statistics, e.g., a binary value derived from the values or their statistics may then be entered and stored into the assertion model.

As not all observations may be computed by a computer by automatic data analysis, other sources of observations may be utilized. For example, block 706 serves as mechanism to provide interpretation aspects or products into the assertion model. Examples include faults, horizons, layers, or geobodies that were picked and designated by a human interpreter working with a traditional interpretation system. In some preferred embodiments of the system, a reference to a specific interpretation product (e.g., a particular fault) and some of its more relevant details may be provided to the assertion model, while the complete specification of this interpretation product are stored by the interpretation system in an often proprietary database or on the file system using some standard data format. The advantage of this embodiment is that it reduces data duplication and thus diminishes the chance for inconsistencies.

Further, the assertion model and the conceptual and interpretation models do have certain differences; while the conceptual model and the interpretational model contain concepts and relations between concepts, the assertion model contains instantiations or instances of said concepts and relations. To give a specific example, while the conceptual model defines faults as a conceptual entity, the assertion model contains specific faults, e.g., ‘fault 11’ or the ‘San Andreas Fault’. ‘fault 11’ is an instantiation of a generic fault concept, while the San Andreas Fault is an instantiation of the strike-slip-fault concept. Observations are instances of concepts, and thus, are stored in the assertion model.

Although optional, preferred embodiments of the present techniques may employ at least one partitioning scheme to break a subsurface region into analysis units, as noted in block 708. The location of observations is useful because specific plays consist of elements with specified relative positions. Distance is useful because the elements of a specific play should be proximal to each other. Many observations, however, are spatially extended or have fuzzy boundaries. Specifying all the coordinates for a specific observation may provide too much detail and excessive amounts of information. Some observations can be characterized by a bounding box, or even one central location. Identification of a specific play may still involve computation of distances and orientations between different observations. In some examples, this may require analysis of every possible combination of observations which is resource intensive. It may be advantageous to locate observations in spatially contiguous regions. The different elements of a specific play should then all be present in one such region, or at least be contained within a set of nearby regions. It may appear that the task merely shifted from finding nearby observations to finding nearby regions which may still involve a combinatorial search. But the number of regions and their locations and properties are under the control of the user, while the number of observations and their locations are not directly under the control of the user.

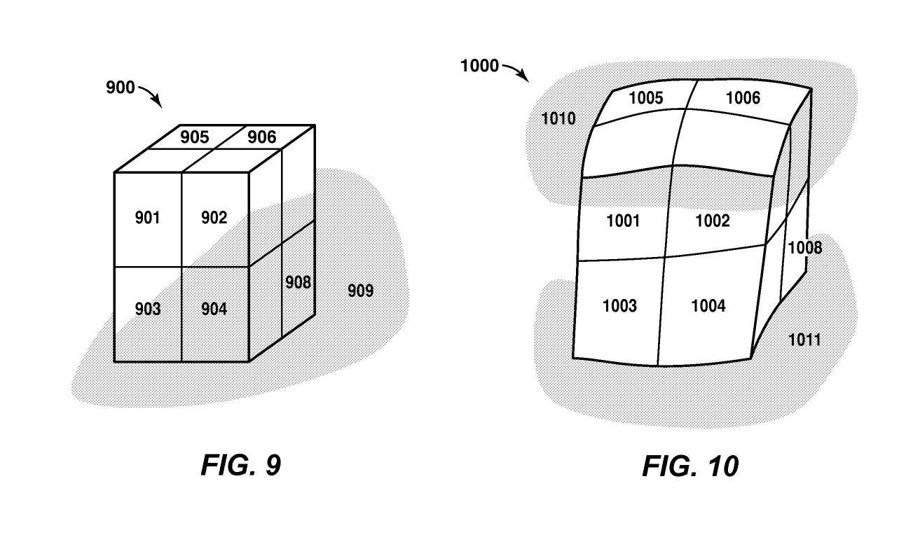

One preferred embodiment of creating partitions is sugar cubing or blocking. In essence, a Cartesian uniform grid is imposed over a specified region in the subsurface. The grid is created without regard to the structures in the subsurface, cutting through features such as faults and surfaces. As an example, FIG. 9 is an exemplary schematic 900 of a sugar-cube or blocked model. FIG. 9 exemplifies this partitioning scheme where the analysis units 901 to 908 form a regular Cartesian grid structure without regard for horizon 909 that cuts through the grid structure.

Another preferred embodiment of creating partitions is a geologic modeling grid that is aligned with user-specified surfaces and/or faults. By creation, such a grid does not cut through faults and surfaces. As an example, FIG. 10 is an exemplary schematic 1000 of a structure following grid. FIG. 10 presents a schematic of such a grid where the analysis units 1001 to 1008 are bounded by surfaces 1010 and 1011. A geologic modeling grid that is aligned with faults is often called a pillar grid. Geologic modeling software to create geologic modeling grids is commercially available and known to those skilled in the art.

In one preferred embodiment of the present techniques, the partitions or analysis units are not mutually exclusive. On the contrary, it may be advantageous to create multiple sets of partitions that are similar in geometry and scale, but spatially shifted with regard to each other. It may also be advantageous to create multiple sets of partitions that differ in scale. In one preferred embodiment of the present techniques, sets of partitions are hierarchically packed into each other.

Preferably, some aspects of the analysis units are stored within the assertion model. For example, a determination may be made with regard to which analysis units abut against each other laterally, which analysis unit is directly above or below (for a given orientation) a specified analysis unit, which analysis units overlap, which analysis units are wholly contained in a specified analysis unit. A reasoner answering a query can use this information to propagate from one analysis unit to another one or to relate observations between different analysis units.

Instead of tying observations, such as attributes, to voxels or coordinates, observations are preferably linked to at least one analysis unit. The assertion model may thus state that a specific analysis unit contains some specific observation, some of whose specific properties are also declared in the assertion model.

It may be advantageous to exploit functionality that is often already built into geologic modeling software by equating a geologic modeling cell with an analysis unit. Geologic modeling software may contain functionality to resample a seismic data or attribute volume to the scale of a geologic modeling grid, often offering different methods of upscaling, averaging, or resampling. Geologic modeling software may contain functionality to query and manipulate properties stored within its cells. Geologic modeling software may also contain algorithms to form geobodies from samples or cells.

Continuing the earlier example, an excerpt of the assertion model may contain the lines of Table 3. As noted in Table 3, the notation is different from the one used in Table 1 and Table 2. The OWL language as shown in Table 1 and Table 2 is preferably used for logical compound statements because OWL in Manchester notation has a compact, human readable syntax. The assertions of Table 3, however, are made using a knowledge representation language known as Resource Description Framework, RDF (http://www.w3.org/TR/rdf-primer/), using a notation known as Notation3, N3 (http://www.w3.org/TeamSubmission/n3/). In a preferred embodiment of the present techniques, entering observations into the assertion model is performed by an algorithm. Although repetitive and lengthy, RDF N3 has a simple syntax for reading and writing (parse and create) with a computer program. Those skilled in the art may understand that OWL can be mapped into RDF. One could say that OWL is based on RDF, or that OWL can be embedded in RDF. The different notations or syntaxes, such as N3, the Manchester notation and others, are equivalent to each other and can be transformed between each other without loss of information in the translation. For any given task, it may be advantageous to prefer one language or notation over others, and thus, it may be advantageous to use different languages or notations for different blocks of the present techniques.

TABLE 3
exemplifies some statements in the assertion model.

| | | |
|---|---|---|
| 16. analysisunit_12 | type | AnalysisUnit |
| 17. analysisunit_12 | isDirectlyAbove | analysisunit_13 |
| 18. analysisunit_12 | isDirectlyBelow | analysisunit_11 |
| 19. analysisunit_12 | hasFacies | HACSeismicFacies |
| 20. analysisunit_12 | hasFoldShape | AntiShape |

Returning to the exemplary assertions in Table 3, Line 16 asserts that ‘analysisunit_{—}12’ is an instance of concept ‘AnalysisUnit’ as indicated by the property (or relation) ‘type’. Lines 17 and 18 assert that ‘analysisunit_{—}12’ has the properties ‘isDirectlyAbove’ some entity ‘analysisunit_{—}13’ and ‘isDirectlyBelow’ some entity ‘analysisunit_{—}11’. These two observations and the resulting assertions stem from the partitioning scheme of block 708. Line 19 asserts that ‘analysisunit_{—}12’ has the property (or relation) ‘hasFacies’ that points to the conceptual property ‘HACSeismicFacies’. Line 20 asserts that ‘analysisunit_{—}12’ has the property (or relation) ‘hasFoldShape’ that points to the conceptual property ‘AntiShape’. Note that items in Table 3 (except for ‘analysisunit_{—}11’, ‘analysisunit_{—}12’, ‘analysisunit_{—}13’ and ‘type’) have been defined in the conceptual model created in block 712. The property or relation ‘type’ is one of the reserved RDF keywords, and thus an element of the RDF or OWL languages. The phrase ‘analysisunit_{—}12’ is simply a unique label or symbol given a particular analysis unit. As it stands in the example of Table 3, ‘analysisunit_{—}11’ and ‘analysisunit_{—}13’ are simply instances of a generic catchall concept. Hopefully, they are explicitly instantiated within the assertion model along the lines of ‘analysisunit_{—}12’ in Table 3. For the sake of clarity, ‘analysisunit_{—}11’, ‘analysisunit_{—}12’, and ‘analysisunit_{—}13’ are all part of the assertion model created in block 709.

At the query stage, there is a conceptual model capturing generic domain knowledge, an interpretational model capturing interpretation assumptions, and an assertion model containing observations, made for example on seismic data. Block 714 is the formulation of at least one query to retrieve either some of the assertions or some facts about the assertions that are implied by the conceptual and interpretational models. Different schemes to store the three models facilitate different querying strategies, some of which are more useful for some applications than others. In one preferred embodiment, the conceptual model and the interpretation model are stored together, while the assertion model is stored in a separate database or repository.

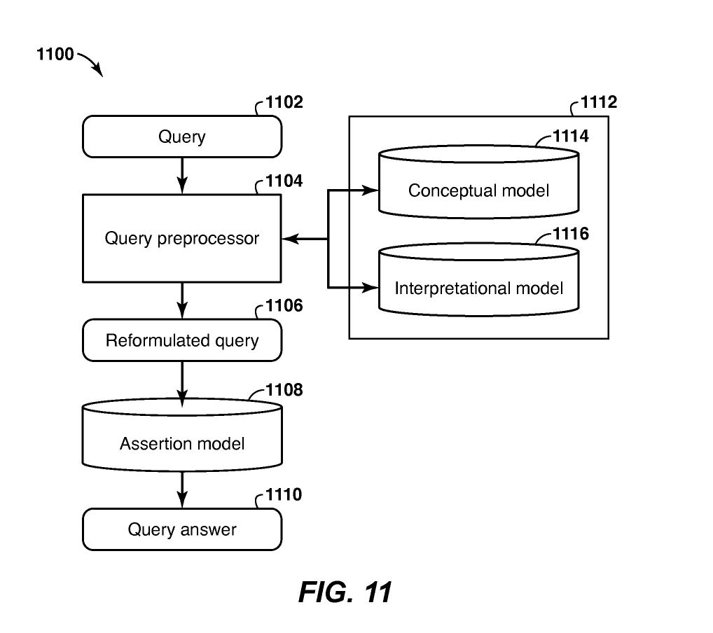

As an example, FIG. 11 is an exemplary flow diagram 1100 of a query answer process in accordance of with an exemplary embodiment of the present techniques. In this flow diagram 1100, a method of such a query where the conceptual model 1114 and the interpretational model 1116 are stored in one repository 1112, while the assertion model is stored in another repository 1108. The two different repositories may be similar or may be of different types. Specifically, the assertion model is preferably stored in a traditional relational database that is optimized for performing conjunctive queries over huge databases. In database theory, a conjunctive query is a restricted form of first-order queries. A large part of queries issued on relational databases can be written as conjunctive queries, and large parts of other first-order queries can be written as conjunctive queries. The conjunctive queries are simply the fragment of first-order logic that can be constructed from operations of conjunction ̂ and existential quantification ∃; but not using disjunction V, negation [symbol] , or universal quantification ∀. Complex queries can often be decomposed into a series of simpler ones. Because there are two repositories, the query may also split into two parts or phases. In the first phase, the original query 1102 is examined based on the conceptual and interpretation models, and the query is then expanded or translated to a second, conjunctive query 1106 that can be submitted to a relational database 1108 in a second phase. The secondary query could, for example, be phrased in the SQL language, as is known to those skilled in the art. The first phase can be viewed as a preprocessor 1104 that translates a first query 1102 to a second query 1106 in view of the conceptual model 1114 and interpretational model 1116. The advantage of such a repository/query system is that massive amounts of data (assertions, observations) can efficiently be queried. The translated queries can be used be used repeatedly even if the assertion model changes. It may be advantageous, however, to keep the queries relatively simple because queries can become large when translated to a set of secondary queries in view of the conceptional and interpretational models. It may be advantageous to use special preprocessors and optimizers to reduce the size, redundancy, and complexity of the secondary queries. It may also be advantageous to reduce the syntactic richness and expressivity of the ontology (e.g., the conceptual model and the interpretation model) to facilitate the transformation of the first query to a manageable set of simple secondary queries.

In another preferred embodiment of the present techniques, all three models are stored in one database or repository. Preferably, a so called triplestore stores the conceptual model, the interpretation model, and the assertion model. A triplestore is a purpose-built database for the storage and retrieval of triples, a triple being a data entity composed of subject-predicate-object relation, like ‘analysisunit_{—}12 isDirectlyAbove analysisunit_{—}13’. Similar to a relational database, one stores information in a triplestore and retrieves it via a query language. Unlike a relational database, a triplestore is optimized for the storage and retrieval of triples. In addition to queries, triples can usually be imported/exported using RDF and other formats. In fact, the example shown in Table 3 is an excerpt from data in a triplestore. A preferred query language is SPARQL (http://www.w3.org/TR/rdf-sparql-query/), a query language for databases that is able to retrieve and manipulate data stored in RDF format. SPARQL allows for a query to consist of triple patterns, conjunctions, disjunctions, and optional patterns. Moreover, an extension to the SPARQL query language called SPARUL or SPARQL/Update (http://www.w3.org/TR/sparql11-update/) provides the ability to insert, delete and update RDF data held within a triplestore or quadstore. A quadstore is an extension of a triplestore where each subject-predicate-object relation is augmented with an additional key or label that may be used to group subject-predicate-object relations into mutually exclusive sets. The advantage of storing all three models in a triplestore that is queried and manipulated with SPARQL/SPARUL is that RDF and SPARQL/SPARUL have simple syntaxes that are easy to read and write, parse and create, or manipulate otherwise with a computer program.

TABLE 4
presents an exemplary query.

21. select * where {
22. analysisunit_12 ?p ?o .
23. }

Table 4 presents an exemplary SPARQL query where the primary statement is Line 22 that asks for everything in the database that relates to ‘analysisunit_{—}13’. Specifically, the example requests every RDF triple that satisfies the pattern ‘analysisunit_{—}12 ?p ?o’ where ‘?p’ and ‘?o’ denote wildcards. If the query is only sent to the assertion model, then the query result is just the asserted data, i.e., Table 3.

In a preferred embodiment of the present techniques, the triplestore itself is stored in a traditional relational database. In a preferred embodiment of the present techniques, the triplestore is stored in a relational database, but loaded into memory for reasoning and query answering. Updates to the triplestore are performed both to the copy stored in memory and the copy stored in the relational database.

In a preferred embodiment, the triple store for the conceptual, interpretational and assertion model is also equipped with a reasoner. A semantic reasoner, reasoning engine, rules engine, or simply a reasoner, is a piece of software able to infer logical consequences from a set of asserted facts or axioms. Within the context of the present techniques, the reasoner infers RDF triples which are unambiguously implied by the conceptual model, interpretational model and assertion model, but are not explicitly stored within these models. If the exemplary query of Table 4 is sent to a conceptual model, interpretational model and assertion model that is also equipped with a reasoner, then additional facts are returned as shown in Table 5.

TABLE 5
exemplifies some facts returned by a
combined model equipped with a reasoner.

| | | |
|---|---|---|
| 24. analysisunit_12 | type | AnalysisUnit |
| 25. analysisunit_12 | isDirectlyAbove | analysisunit_13 |
| 26. analysisunit_12 | isDirectlyBelow | analysisunit_11 |
| 27. analysisunit_12 | hasFacies | HACSeismicFacies |
| 28. analysisunit_12 | hasFoldShape | AntiShape |
| 29. analysisunit_12 | type | AnticlineFold |
| 30. analysisunit_12 | type | SeismicFaciesUnit |
| 31. analysisunit_12 | type | SealedSandLayer |
| 32. analysisunit_12 | type | AnticlinePlay |

Lines 24 to 28 of Table 5 are expected because they are explicitly asserted in the assertion model as demonstrated in Table 3. Line 29 of Table 5 states that the entity ‘analysisunit_{—}12’ is a member of the ‘AnticlineFold’ concept which is a consequence of Line 4. Line 30 of Table 5 states that the entity ‘analysisunit_{—}12’ is a member of the ‘SeismicFaciesUnit’ concept which is a consequence of having a seismic facies assigned to it. Line 31 of Table 5 states that entity ‘analysisunit_{—}12’ is a member of the ‘SealedSandLayer’ concept which is in part a consequence of Line 8. Line 32 of Table 5 states that entity ‘analysisunit_{—}12’ is a member of the ‘AnticlinePlay’ concept which is in part a consequence of Line 10.

Examples for other queries that may be performed include a request for all entities that are a member of a specified concept, a request for all instances of a specified concept, a request for all instances that have a specified property or relate to a specified instance. Another type of query is a determination whether a specified triple is explicitly or implicitly contained in the models or not contained in the models. An example may be to determine whether or not ‘analysisunit_{—}12’ is a member of the ‘AnticlinePlay’ concept, which should be affirmative.

Preferably, the reasoner can also be queried for a justification or an explanation why a specified instance is a member of some concept, or more generically, why a specific result is returned. The justification could be one Line number if the instance is explicitly asserted to be a member of a concept or a set of Lines if there is an implicit link between a specified instance and a specified instance or concept. Potentially, the justification could be multiple sets of Lines if there are multiple paths to link an instance to a concept or another instance, e.g., if there are multiple explanations for the specified relations. At times, the assertion model may contain contradictory facts, in which case the reasoned might list which assertions are contradictory in light of which parts of the conceptual and interpretational models. Preferably, the reasoned is also used to validate the internal consistency of the conceptual and/or interpretational models.

To summarize block 714, an interpreter or an agent, acting for example on the interpreter's behalf, creates a query and sends it to a data repository that includes a conceptual model, an interpretational model, and an assertion model. The repository, augmented by a reasoner, examines the models for entries that satisfy the query either explicitly or implicitly, and returns the matches or their justifications to the interpreter or agent.

The returned results are analyzed, as noted in block 716, for example by visualization. Preferred methods of visualizing the results of a given query include highlighting satisfied analysis units or suppressing unfulfilled ones. Highlighting and suppressing may be performed by color coding, shading, or (partial) transparency. In a preferred embodiment, the results from multiple queries are combined or encoded by assigning specific combinations to specific colors. The interpreter may discover that some expected successes are missing or that some expected failures are returned, indications that the assertion model (e.g., observations) are inadequate or incorrect, that assumptions in the interpretational model are insufficient or incorrect, or that the conceptual model incorrectly represents the domain of hydrocarbon accumulations. The interpreter may need to revise the assumptions in the interpretation model (as noted in block 710), the observations in the assertion model (as noted in blocks 704 and 706), or as a last resort, the conceptual model itself (as noted in block 712). Thus, in a preferred embodiment, the interpreter or the agent interactively refines the queries, adjusts the interpretational (and conceptual) assumptions, and manipulates the observations, effectively looping over blocks 704, 706, 709, 710, 714 and 716.

Once the returned results are deemed satisfactory or at least sufficient, the interpreter may want to rate and rank the results, as noted in block 718. In some preferred embodiments of the present techniques, a query simply returns the labels of the analysis units that satisfy a specified criterion, such as containing a specified play type. Any given analysis unit is either contained in the returned list or not contained in the returned list. Potentially a large number of analysis units are returned. As noted in optional block 718, the returned analysis units may be rated and ranked based on some criterion or measure specified by the user. In a preferred embodiment, scores are computed for some analysis units that are used to rate and rank these units. An exemplary score may be prospectivity, as disclosed in Intl. Application No. 2011149609, either by direct computation for individual analysis units or by scaling up prospectivity from the individual samples to analysis units.

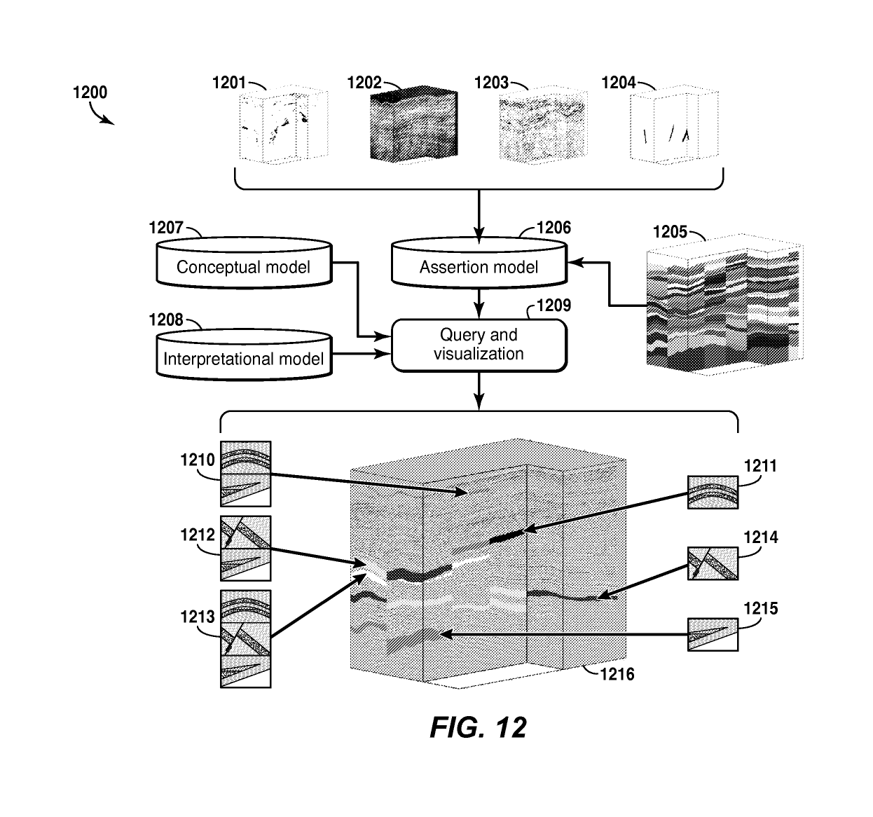

FIG. 12 is a diagram 1200 of an exemplary application of the play recognition method in accordance with an exemplary embodiment of the present techniques. In this diagram 1200, four different seismic attributes 1201 to 1204 are computed from seismic data to provide observations. Attribute 1201 is a seismic-closure volume computed from thousands of automatically computed surfaces. Each of these surfaces is analyzed for anticlinal shapes. Attribute 1202 is a seismic-facies volume that encodes nine seismic facies types ranging from low-amplitude transparent to high-amplitude continuous. Attribute 1203 is a convergence volume that indicates locations where reflections converge or diverge. Attribute 1204 is a fault volume that indicates locations where a fault exists. Attributes 1201 to 1203 are computed automatically from seismic data using a computer, which relates to block 704, while the fault-volume attribute is derived from manually picked fault sticks, which relates to block 706.

Seismic analysis units 1205 are defined by partitioning the seismic volume into smaller units that follow the structure or reflections, i.e., analysis units that are bound by reflections. For simplicity, all pillars are strictly vertical (e.g., they do not follow the fault planes). Each analysis unit is of lateral size 111×111 voxels. Their vertical size varies with location, but averages to around 30 voxels. Each analysis unit is given a unique label, e.g., ‘analysisunit_{—}12’. In a first step, each unit is entered into the assertion model 1206 by creation of an analysis unit with a unique label. For this example, analysis unit 1205 exhibits around one thousand individual analysis-unit instances. Some metadata are assigned to each entry including location, size, and a unique identifying number, e.g, ‘12’ for ‘analysisunit_{—}12’. In a second step, vertically juxtaposed analysis units are entered into the assertion model using the ‘isDirectlyAbove’ and ‘isDirectlyBelow’ relationships. In a third step, the individual samples of volumes 1201 to 1204 inside the analysis units 1205 are used to automatically make observations and enter these observations to the assertion model 1206. If any sample inside an analysis unit exhibits closure, then the ‘hasFoldShape AntiShape’ property is assigned to this analysis unit. To be more specific, the closure attribute 1201 that was used indicates the areal extent of the closure. In one embodiment, the interpreter specifies an areal threshold for closure. If a sample inside an analysis units exceed this threshold, then the ‘hasFoldShape AntiShape’ property is assigned to this analysis unit. In a preferred embodiment, the maximal non-zero areal extent of closure encountered within each analysis unit is also entered into the assertion model using the ‘hasArea’ property. The interpreter applies the threshold through definitions in the interpretation model 1208. Using the seismic-facies volume 1202, a computer program determines the dominant seismic facies for each analysis unit by majority voting. The dominant facies is then entered into the assertion model, e.g., ‘hasFacies HACSeismicFacies’. If according to the convergence volume 1203 an analysis unit contains converging strata, then the relation ‘contains Termination’ is entered into the assertion model. Again, either the interpreter specifies a convergence threshold that a computer program uses to decide whether to enter a ‘contains Termination’ relation or not; or preferably, the maximal convergence value within each analysis unit is entered into the assertion model and the interpreter specifies a threshold through the interpretation model. Lastly, if there is any sample with fault indication 1204 in an analysis unit, then the property ‘contains FaultStructure’ is entered into the assertion model. Preferably, instead of the simple assertion that the analysis unit contains the concept of ‘FaultStructure’ (e.g., a generic or anonymous instance of the ‘FaultStructure’ concept), the fault itself is given a unique label (e.g., ‘fault_{—}11’), entered into the assertion model as an instance of the concept ‘FaultStructure’, and the analysis unit is given the ‘contains fault_{—}11’ property. Table 3 presents just a small excerpt of the assertion model 1206.

In a preferred embodiment of this example, the pillar grid may be guided by the faults, in which case no fault may intersect any analysis unit. Consequently, the property ‘contains FaultStructure’ may need to be replaced by the property ‘isBoundedBy FaultStructure’; or preferably ‘contains fault_{—}11’ is replaced by ‘isBoundedBy fault11’ where ‘fault11’ is an instance of the ‘FaultStructure’ concept or one of its subconcepts such as ‘NormalFaultStructure’. Preferably, the definition of the ‘FaultTrapPlay’ concept is extended to capture both the case of analysis units intersected by faults as well as the case of analysis units bounded by faults.

Table 1 and Table 2 present just small excerpts of the combined conceptual and interpretation models 1207 and 1208 that describe many concepts and assumptions with regard to hydrocarbon accumulations, plays and related domains, which are discussed and outlined in FIG. 8. A computer program then executes queries 1209 along the lines of Table 6 requesting the unique identifier numbers for analysis units that are members of the ‘AnticlinePlay’ concept.

TABLE 6
presents another example query.

33. select ?n where {
34. ?s type AnticlinePlay .
35. ?s hasID ?n .
36. }

Similar queries are performed for the concepts ‘FaultTrapPlay’, ‘PinchoutPlay’ and ‘SaltPlay’, whose definitions are indicated in the discussion of FIGS. 3, 4 and 5. Detailed definitions follow roughly the template provided by the excerpt of the ‘AnticlinePlay’ presented in Table 1. Because the example does not contain any salt, the salt-indicator volume is empty, the computer program does not assign a ‘contains Salt’ property to any analysis unit, and queries with regard to ‘SaltPlay’ remain unfulfilled.

A computer program combines and visualizes the results of the different queries 1209. One particular manner of presenting the seismic analysis units that satisfy any given query is by visually coding the successful units, for example by highlighting those units with colors or shading the units with textures in model 1216. Area 1210 corresponds to analysis units that satisfy both the definition of anticline plays and pinchout plays, while area 1211 corresponds to analysis units that satisfy only the definition for anticline plays. Area 1212 corresponds to analysis units that satisfy both the definition of fault-trap plays and pinchout plays, while area 1213 corresponds to analysis units that satisfy simultaneously the definitions of anticline plays, fault-trap plays, and pinchout plays. Area 1214 corresponds to analysis units that satisfy only the definition for fault-trap plays, while area 1215 corresponds to analysis units that satisfy only the definition for pinchout plays.

If after review and inspection, some location does not exhibit an expected play or if some locations exhibit an incorrect play, then the interpreter reexamines and modifies the assumptions or returns to the observations and the agents providing the observations.

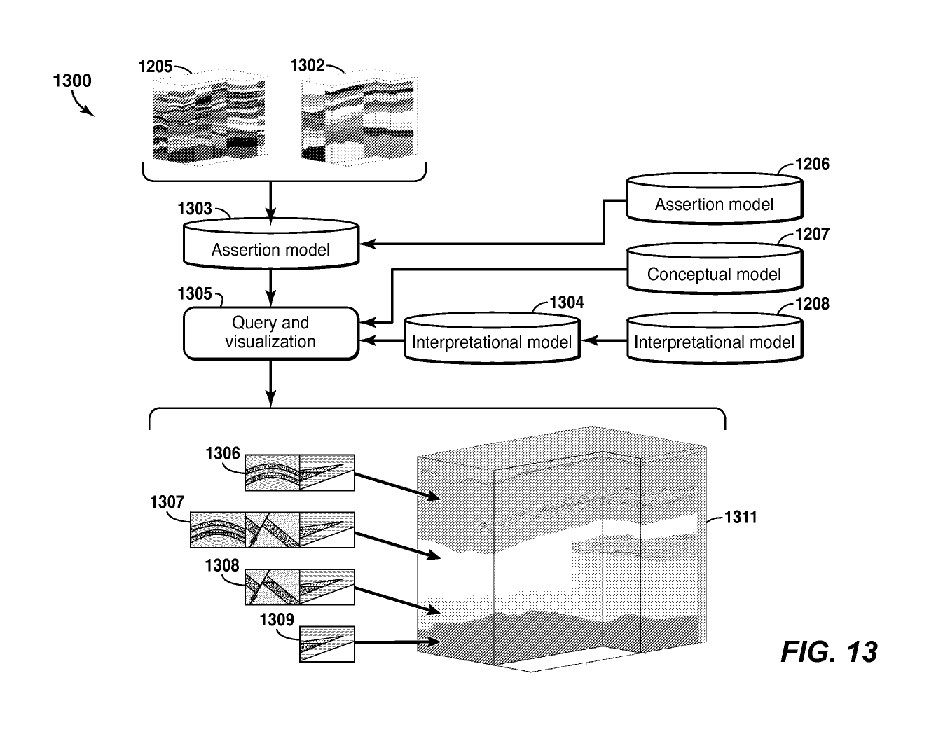

As another example, FIG. 13 is a diagram of another exemplary application of the method in accordance with an exemplary embodiment of the present techniques. In this diagram 1300, the example begins again with the formation of the assertion model 1206 from the seismic attributes 1201 to 1204 based on the analysis units 1205. In this example, however, a second set of analysis units 1302 are defined that overlap with the first one (e.g., analysis units 1205). Analysis units 1302 are of lateral size 420×170 samples. Their vertical extent averages to around 100 samples. Each analysis unit of analysis units 1302 contains (or overlaps) with up to 30 analysis units of analysis units 1205. Instead of making new observations for 1302 that need to be entered into the assertion model, the existing assertion model 1206 of FIG. 12 that contains data about the analysis units 1205 and associated observations is augmented with data on how the analysis units of analysis units 1205 and analysis units 1302 relate. Thus, the assertion model 1206 is augmented with relations to form the assertion model 1303 defining label, size, location, identification number and the juxtaposition relationships for the larger analysis units and stating which analysis units of 1206 are at least partially contained in which analysis units of 1302. For simplicity, the assertion model 1303 is designated as a new assertion model that contains both the original assertions (e.g., assertion model 1206) and the new relationships between the analysis units 1205 and 1302.

The interpreter adds additional assumptions into the interpretation model 1304 augmenting the original interpretation model 1208 to state that when a first analysis unit contains at least partially a second analysis unit that contains an observation, then the first analysis unit also contains said observation. Specifically, some of the relations are defined to be transitive or to be chaining. For simplicity, interpretation model 1304 is designated the new interpretation model that contains both the original interpretation model (e.g., interpretation model 1208 of FIG. 12) and the additional properties that allow chaining or the interchange of properties between overlapping analysis units.

Again, a computer program performs queries with regard to which analysis units contain specific plays such as anticline plays, fault-trap plays, pinchout plays, salt plays, and combinations thereof. The query returns results for both scales of analysis units 1205 and 1302, but for the sake of clarity, model 1311 shows which analysis units of 1302 contain which play types. The region 1306 corresponds to analysis units of analysis units 1302 that simultaneously satisfy definitions for anticline plays and pinchout plays. Note that the plural word “definitions” is used to emphasize that multiple definitions can be used for the same concept. It may be advantageous to define one generic concept, parent concept, or super concept, e.g., ‘SealedSandLayer’, which is further specified by one of multiple subconcepts (child concepts) with explicit definitions, conditions and constraints, e.g., ‘SealedSandLayerDef1’ and ‘SealedSandLayerDef2’. In one definition, some specified conditions may have to be satisfied in vertically adjacent analysis units; while in another definition, all specified conditions must be satisfied within the same analysis unit. In the former case, an analysis unit with the ‘SandLayer’ property is directly below an analysis unit with the ‘ShaleLayer’ property. In the latter case, one analysis unit exhibits both the ‘SandLayer’ and the ‘ShaleLayer’ property. Multiple definitions facilitate transfer of observations across scales. Moreover, this strategy separates the conceptual concept from its specific definitions which facilitates reuse and maintenance of the conceptual and interpretational models.

The region 1307 corresponds to analysis units of 1302 that satisfy at least one definition for each play in the set of anticline play, fault-trap play, and pinchout play. The region 1308 corresponds to analysis units of 1302 that satisfy at least one definition for each play in the set of fault-trap play and pinchout play. The region 1309 corresponds to analysis units of 1302 that satisfy at least one definition for pinchout play.

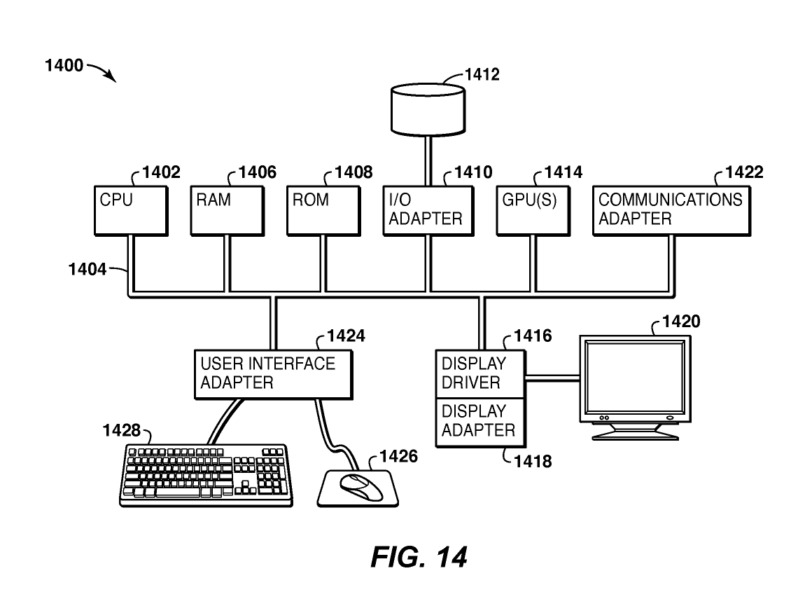

FIG. 14 is a block diagram of a computer system 1400 that may be used to perform any of the methods disclosed herein. A central processing unit (CPU) 1402 is coupled to system bus 1404. The CPU 1402 may be any general-purpose CPU, although other types of architectures of CPU 1402 (or other components of exemplary system 1400) may be used as long as CPU 1402 (and other components of system noted above) supports the inventive operations as described herein. The CPU 1402 may execute the various logical instructions according to disclosed aspects and methodologies. For example, the CPU 1402 may execute machine-level instructions for performing processing according to aspects and methodologies disclosed herein.

The computer system 1400 may also include computer components such as a random access memory (RAM) 1406, which may be SRAM, DRAM, SDRAM, or the like. The computer system 1400 may also include read-only memory (ROM) 1408, which may be PROM, EPROM, EEPROM, or the like. RAM 1406 and ROM 1408 hold user and system data and programs, as is known in the art. The computer system 1400 may also include an input/output (I/O) adapter 1410, a communications adapter 1422, a user interface adapter 1424, and a display adapter 1418. The I/O adapter 1410, the user interface adapter 1424, and/or communications adapter 1422 may, in certain aspects and techniques, enable a user to interact with computer system 1400 to input information.

The I/O adapter 1410 preferably connects a storage device(s) 1412, such as one or more of hard drive, compact disc (CD) drive, floppy disk drive, tape drive, etc. to computer system 1400. The storage device(s) may be used when RAM 1406 is insufficient for the memory requirements associated with storing data for operations of embodiments of the present techniques. The data storage of the computer system 1400 may be used for storing information and/or other data used or generated as disclosed herein. The communications adapter 1422 may couple the computer system 1400 to a network (not shown), which may enable information to be input to and/or output from system 1400 via the network (for example, a wide-area network, a local-area network, a wireless network, any combination of the foregoing). User interface adapter 1424 couples user input devices, such as a keyboard 1428, a pointing device 1426, and the like, to computer system 1400. The display adapter 1418 is driven by the CPU 1402 to control, through a display driver 1416, the display on a display device 1420. Information and/or representations of one or more two-dimensional (2D) canvases and one or more three-dimensional (3D) windows may be displayed, according to disclosed aspects and methodologies.

The architecture of system 1400 may be varied as desired. For example, any suitable processor-based device may be used, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may use any number of suitable structures capable of executing logical operations according to the embodiments.

In one or more embodiments, the method, such as the any one describes in FIGS. 6 to 13, for example, may be implemented in machine-readable logic, set of instructions or code that, when executed, performs a method to analyze hydrocarbon allocations by performing the steps of obtaining a conceptual model of one or more subsurface hydrocarbon play concepts; obtaining an assertion model of one or more observations; obtaining an interpretational model having one or more interpretational assumptions and link one or more of the observations to one or more of the hydrocarbon play concepts; submitting a query for instances of one of the one or more hydrocarbon play concepts or classifying observations with regard to different concepts; and providing a report of the query results. The code may be used or executed with a computing system, such as computing system 1400.

Illustrative, non-exclusive examples of methods and products according to the present disclosure are presented in the following non-enumerated paragraphs. It is within the scope of the present disclosure that an individual step of a method recited herein, including in the following enumerated paragraphs, may additionally or alternatively be referred to as a “step for” performing the recited action.

One or more exemplary embodiments are described below in the following paragraphs.

1. A method for analyzing data representing a subsurface region for the presence of a hydrocarbon accumulation, comprising:
defining a conceptual model of one or more subsurface hydrocarbon play concepts;
defining an assertion model of one or more observations;
defining an interpretational model having one or more interpretational assumptions and link one or more of the observations to one or more of the hydrocarbon play concepts;
submitting a query for instances of one of the one or more hydrocarbon play concepts or classifying observations with regard to different concepts; and
providing a report of the query results.
2. The method of paragraph 1, wherein the query is performed with regard to at least one subsurface location, which may be along the line of Table 5. For example, the method may include a specific phrase, such as “give me everything you know about analysis_unit_{—}12”, to obtain information about this specific analysis unit.

It should be understood that the preceding is merely a detailed description of specific embodiments of the invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

1. A method for analyzing data, comprising seismic data and representing a subsurface region, for presence of a hydrocarbon accumulation, comprising:
defining a conceptual model of one or more subsurface hydrocarbon play concepts, said one or more play concepts including an anticline play or a normal-fault-trap play or a pinch-out play or a salt-flank play or another type of play defined by its trapping configuration;
defining an assertion model of one or more observations based on the data or an attribute derived therefrom;
defining an interpretational model having one or more interpretational assumptions and linking one or more of the observations to one or more of the hydrocarbon play concepts;
submitting a query, using a computer, for instances of one of the one or more hydrocarbon play concepts or classifying observations with regard to different concepts; and
providing a report of the query results.

2. The method of claim 1, wherein the one or more interpretational assumptions form a relationship between the one or more observations and the one or more hydrocarbon play concepts.

3. The method of claim 2, wherein the one or more interpretational assumptions are obtained from an interpreter sequentially in a series of assumptions to explore different scenarios.

4. The method of claim 2, wherein the one or more interpretational assumptions are obtained from an interpreter interactively making assumptions and interactively submitting queries.

5. The method of claim 2, wherein the one or more interpretational assumptions involve tagging or labeling one or more of the observations based on one or more hydrocarbon play concepts.

6. The method of claim 1, wherein the one or more observations comprise geologic attributes derived from seismic data.

7. The method of claim 1, wherein the one or more observations comprise picking horizons and faults based on seismic data.

8. The method of claim 1, wherein the one or more observations are based on one or more of seismic data, geophysical data, wireline data, and field analogues.

9. The method of claim 1, wherein the query is formulated by a query agent and transmitted to a database storing one or more of the conceptual model, assertion model, and interpretational model.

10. The method of claim 1, comprising displaying the report of the query results on a monitor.

11. The method of claim 1, comprising determining one or more leads based on the report of the query results.

12. The method of claim 11, comprising ranking the one or more leads based on estimated volume or minimal estimated risk.

13. The method of claim 1, wherein the one or more subsurface hydrocarbon play concepts comprise one or more an anticline play, a normal-fault-trap play, a pinchout play and a salt-flank play.

14. A system for analyzing data, comprising seismic data and representing a subsurface region, for the presence of a hydrocarbon accumulation, comprising:
a processor;
memory coupled to the processor; and
a set of instructions stored in memory and when executed are configured to:
define a conceptual model of one or more subsurface hydrocarbon play concepts, said one or more play concepts including an anticline play or a normal-fault-trap play or a pinch-out play or a salt-flank play or another type of play defined by its trapping geometry;
define an assertion model of one or more observations based on the data or an attribute derived therefrom;
define an interpretational model having one or more interpretational assumptions and linking one or more of the observations to one or more of the hydrocarbon play concepts;
submit a query for instances of one of the one or more hydrocarbon play concepts or classifying observations with regard to different concepts; and
store a report of the query results.

15. The method of claim 14, wherein the set of instructions stored in memory and when executed are configured to display the query results via a monitor.
